(19) United States
(12) Patent Application Publication
(10) Pub. No.: US 2014/0003082 A1
(43) Pub. Date: Jan. 2, 2014

(54) LICENSE PLATE LIGHTING APPARATUS

(71) Applicant: Jeffrey Jose' Calderas, Royal Oak, MI (US)

(72) Inventor: Jeffrey Jose' Calderas, Royal Oak, MI (US)

(73) Assignee: GM GLOBAL TECHNOLOGY OPERATIONS LLC, Detroit, MI (US)

(21) Appl. No.: 13/534,525

(22) Filed: Jun. 27, 2012

(51) Int. Cl. B60Q 1/56; F21V 8/00

(52) U.S. Cl. 362/555

(57) ABSTRACT

A lighting apparatus for illuminating a license plate includes an LED element and an appliqué. The appliqué has an exterior surface, which is substantially opaque, facing away from the license plate and an interior surface facing toward the license plate. A light guide is disposed between the exterior surface and the license plate, and has a first end with a first optic formed thereon. The light guide carries light from the LED element to the first optic and casts light onto the license plate.

### TECHNICAL FIELD

This disclosure relates to lighting or illumination of license plates or registration plates.

### BACKGROUND

Automobiles and other vehicles carry license plates, registration plates, or other registration identifiers. Many governments require the license plate to be attached to the rear of the vehicle, the front of the vehicle, or both. Additionally, private entities may use plates to assist in identifying vehicular equipment, such as in manufacturing or assembly facilities.

### SUMMARY

A lighting apparatus for illuminating a license plate is provided. The lighting apparatus includes an LED element and an appliqué. The appliqué has an exterior surface facing away from the license plate and an interior surface facing toward the license plate. The exterior surface of the appliqué is substantially opaque.

A light guide is disposed between between the exterior surface of the appliqué and the license plate. The light guide has a first end with a first optic formed thereon. The light guide carries light from the LED element to the first optic, and the first optic casts light or a light pattern onto the license plate.

The above features and advantages, and other features and advantages, of the present invention are readily apparent from the following detailed description of some of the best modes and other embodiments for carrying out the invention, which is defined solely by the appended claims, when taken in connection with the accompanying drawings.

### BRIEF DESCRIPTION OF THE DRAWINGS

FIG. 1 is a schematic elevation view of a rear portion of a vehicle having a license plate illuminated by a lighting apparatus;

FIG. 2 is a schematic plane-intersection view of the lighting apparatus taken along a line 2-2 of FIG. 1;

FIG. 3 is a schematic plane-intersection view of another lighting apparatus having an integrated appliqué and light guide, taken from a viewpoint similar to the line 2-2 of FIG. 1;

FIG. 4 is a schematic plane-intersection view of another lighting apparatus having a mid-mounted LED element, taken from a viewpoint similar to the line 2-2 of FIG. 1;

FIG. 5 is a schematic isometric view of a rear bumper portion of a vehicle having a license plate illuminated by a lighting apparatus;

FIG. 6 is a schematic cross-sectional view of the lighting apparatus taken along a line 6-6 of FIG. 5; and

FIG. 7 is a schematic plane-intersection view of another lighting apparatus having a backlit emblem, taken along a line 7-7 of FIG. 1, which is similar to the line 2-2 but closer to a centerline of the vehicle.

### DETAILED DESCRIPTION

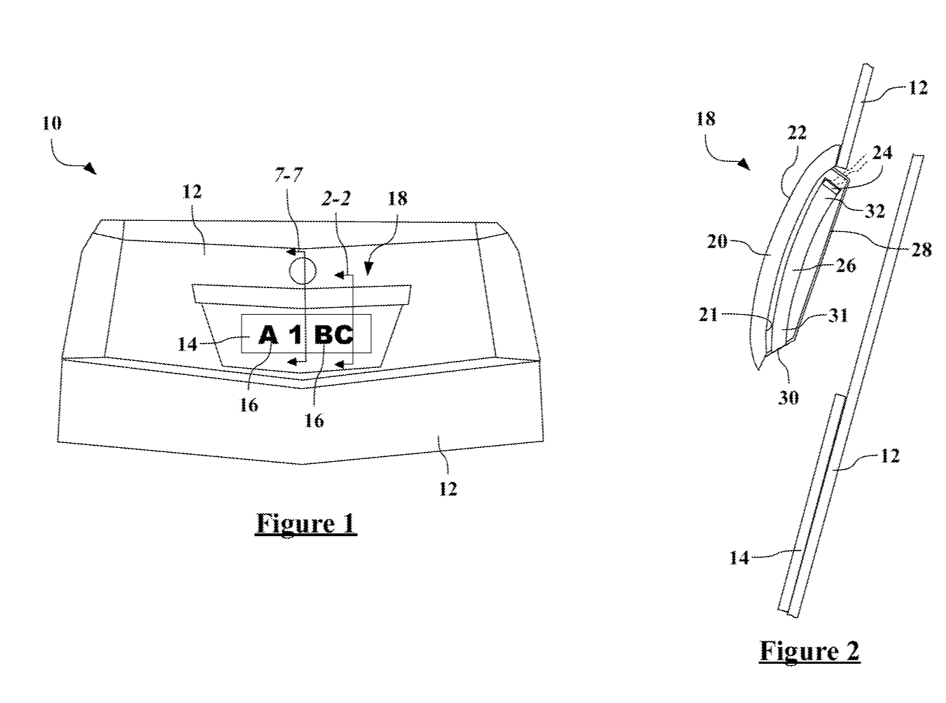

Referring to the drawings, wherein like reference numbers correspond to like or similar components wherever possible throughout the several figures, there is shown in FIG. 1 a vehicle 10. FIG. 1 shows only a rear portion of the vehicle 10, and the type of vehicle shown is illustrative only.

While the present invention may be described with respect to automotive applications, those skilled in the art will recognize the broader applicability of the invention. Those having ordinary skill in the art will recognize that terms such as “above,” “below,” “upward,” “downward,” et cetera, are used descriptively of the figures, and do not represent limitations on the scope of the invention, as defined by the appended claims. Any numerical designations, such as “first” or “second” are illustrative only and are not intended to limit the scope of the invention in any way.

The rear of the vehicle 10 includes a deck lid 12, which may commonly be referred to as a trunk or trunk lid. A license plate 14 is operatively attached to, or disposed on, the deck lid 12, such that it may generally be viewed from behind the vehicle 10. As used herein, the deck lid 12 may also incorporate portions of the rear bumper or rear fascia, and refers generally to portions of the vehicle 10 to which the license plate 14 may be attached. While the license plate 14 is shown on the rear of the vehicle 10 in FIG. 1, the license plate 14 may also be disposed on the front portion of the vehicle 14. The license plate 14 includes characters 16, which may include, without limitation, one or more numbers, letters, symbols, or combinations thereof

A lighting apparatus 18 is located above the license plate 14 and is also operatively attached to the deck lid 12. The lighting apparatus 18 illuminates the license plate 14, as may be required to facilitate reading the characters 16. Note that the lighting apparatus 18 may be similarly mounted in a bumper (not shown) of the vehicle 10 above or below the license plate 14.

Referring now to FIG. 2, and with continued reference to FIG. 1, there is shown another view of portions of the vehicle 10 and the lighting apparatus 18. The view shown in FIG. 2 is a schematic, plane-intersection view taken approximately along line 2-2 of FIG. 1. The plane-intersection view illustrates the edges of components intersecting the view plane but generally does not show objects in the background, as may be shown in cross-sectional views.

Note that the line 2-2 shown is somewhat offset from the centerline of the vehicle 10. However, the schematic view shown in FIG. 2 (and others) may also be illustrative of section lines taken at the centerline of the vehicle 10, such as a line 7-7, depending upon the configuration of the lighting apparatus 18.

The lighting apparatus 18 includes an appliqué 20. An interior surface 21 of the appliqué 20 faces toward the license plate 14. In the schematic view of FIG. 2, the license plate 14 may not be shown to scale, and the license plate may be much longer (vertically, as viewed in the figures) than shown.

An exterior surface 22 of the appliqué 20 faces away from the license plate 14, and is either substantially opaque or is substantially covered with an opaque coating. The opaque exterior surface 22 may be covered by, without limitation, chrome-plating, paint, or other decorative or protective metallic coatings. For example, the appliqué 20 may be formed from clear or colored ABS plastic and either chrome-plated or painted to match the body color of the vehicle 10 or as an accent color. Alternatively, the appliqué 20 may be formed from an opaque material, such as opaque plastic or metal, and the opaque material may also be painted or coating.

A light-emitting diode or LED element 24 acts as the light source for the lighting apparatus 18. A light guide 26 is disposed between the exterior surface 22 of the appliqué 20 and the license plate 14. In the configuration shown, a housing plate 28 is disposed between the interior surface 21 of the appliqué 20 and the license plate 14. The housing plate 28 may also be substantially opaque, translucent, or transparent.

The light guide 26 carries light from the LED element 24 and casts it onto the license plate 14. A first optic 30 is formed on a first end 31 of the light guide 26. The light guide 26 has a second end 32 substantially opposite the first end 31. In the configuration shown in FIG. 2, the LED element 24 is at the second end 32, such that the LED element 24 is either adjacent to, or embedded within, the second end 32. In the configuration shown, the light guide 26 carries light from the LED element 24 to the first optic 30 substantially via total internal reflection.

The first optic 30 casts light or a light pattern onto the license plate 14, such that the license plate 14 is illuminated by the lighting apparatus 18. The light pattern cast by the first optic 30 and the light guide 26 may be a single, large region substantially covering the whole of the license plate 14. Alternatively, the light pattern may consist of multiple regions and distributions of light intensity that, in combination, illuminate the characters 16.

The first optic 30 may be a simple projection surface or lens that is at a sufficient angle to prevent total internal reflection and cause light from the LED element 24 to escape the light guide 26 and be cast or projected onto the license plate 14. There may be additional optical features along the length of the light guide 26 between the LED element 24 and the first optic 30. For example, the light guide 26 surfaces may have optical elements or texture along their lengths to aid in directing light through the light guide 26 to the first optic 30 at the first end 31 of the light guide 26.

The appliqué 20 shown is attached to the deck lid 12. However, the appliqué 20 may also be a portion of the deck lid 12 that houses the light guide 26 and provides the light-blocking function of the opaque exterior surface 22.

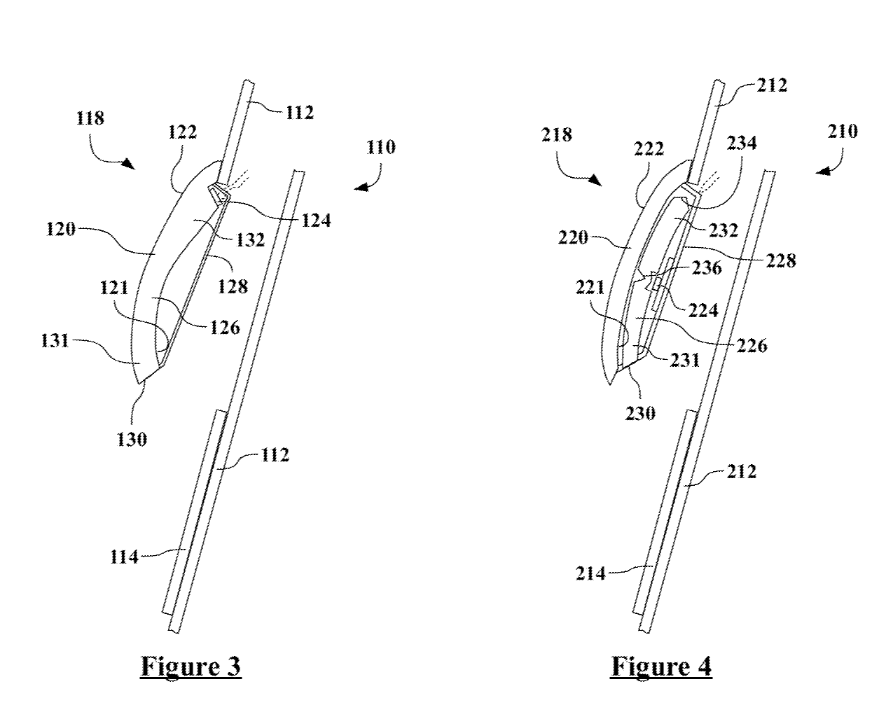

Referring now to FIG. 3, and with continued reference to FIGS. 1-2, there is shown a portion of another vehicle 110 having a deck lid 112 with a license plate 114 attached thereto. A lighting apparatus 118 illuminates the license plate 114. FIG. 3 shows a plane-intersection view taken from a similar viewpoint to the line 2-2 from FIG. 1, and the lighting apparatus 118 shown in FIG. 3 may also be used with the vehicle 10 of FIG. 1.

Features shown in one figure may be combined with, substituted for, or modified by, features shown in any of the figures. Unless stated otherwise, no features, elements, or limitations are mutually exclusive of any other features, elements, or limitations. Any specific configurations shown in the figures are illustrative only and the specific configurations shown are not limiting of the claims or the description.

The lighting apparatus 118 includes an appliqué 120 having an exterior surface 122 that faces away from the license plate 114 and, an interior surface 121 that faces toward the license plate 114. The exterior surface 122 is substantially covered with an opaque coating, which may be, without limitation, chrome-plating or paint.

An LED element 124 acts as the light source for the lighting apparatus 118, and a light guide 126 carries light from the LED element 124 and casts it onto the license plate 114. In the lighting apparatus 118, the appliqué 120 and the light guide 126 are integrated into a one-piece, unitary element. The appliqué 120 may be formed from, for example, clear ABS plastic and either chrome-plated or painted to match the body color of the vehicle 110 or as an accent color.

In the configuration shown, a housing plate 128 is disposed between the interior surface 121 of the appliqué 120 and the license plate 114. The housing plate 128 may be substantially opaque, translucent, or clear.

A first optic 130 is formed on a first end 131 of the light guide 126. The light guide 126 has a second end 132 substantially opposite the first end 131. In the configuration shown in FIG. 3, the LED element 124 abuts, or is embedded within, the second end 132. The light guide 126 carries light from the LED element 124 to the first optic 130, which distributes the light to the license plate 114.

In some configurations, the light guide 126 may be coated with materials on one or more sides that have a lower index of refraction than the light guide 126. These low-refraction coatings would allow for more efficient conduction of the light from the LED element 124 to the first optic 130 substantially via total internal reflection.

Because the appliqué 120 and the light guide 126 are integrated into a one-piece, unitary element, the first end 131 of the light guide 126 is also the first end 131 of the appliqué 120 and the exterior surface 122 of the appliqué 120 is also the exterior surface 122 of the light guide 126. Alternatively, instead of the housing plate 128, the interior surface of the light guide 126 may be covered in a substantially-opaque coating. However, coatings may reduce the amount of light reflected by the surfaces and may absorb some of the light which may limit the amount of light passed through the light guide 126.

The lighting assembly 118, with the appliqué 120 and the light guide 126 integrated into one piece, may be attached to the deck lid 112 as a single unit. Furthermore, the combined width of the appliqué 120 and the light guide 126 may be less than that shown in FIG. 2, and the total distance of the lighting apparatus 118 from the deck lid 112 and the license plate 114 may be reduced.

The LED element 124 may be a single LED that produces sufficient light for the whole license plate 114. However, the LED element 124 may include a plurality of individual LED's, which are distributed across the second end 132 of the light guide 126. Numerous patterns and arrangements of individual LED's may be used for the LED element 124.

Referring now to FIG. 4, and with continued reference to FIGS. 1-3, there is shown a portion of another vehicle 210 having a deck lid 212 with a license plate 214 attached thereto. A lighting apparatus 218 illuminates the license plate 214. FIG. 4 shows a plane-intersection view taken from a similar viewpoint to the line 2-2 from FIG. 1, and the lighting apparatus 218 shown in FIG. 4 may also be used with the vehicle 10 of FIG. 1.

The lighting apparatus 218 includes an appliqué 220 having an interior surface 221 that faces toward the license plate 214 and an exterior surface 222 that faces away from the license plate 214. The exterior surface 222 is substantially covered with an opaque coating, which may be, without limitation, chrome-plating or paint.

An LED element 224 acts as the light source for the lighting apparatus 218, and a light guide 226 carries light from the LED element 224 and casts it onto the license plate 214. In the configuration shown, a housing plate 228 is disposed between the interior surface 221 of the appliqué 220 and the license plate 214. The housing plate 228 may be substantially opaque, translucent, clear, or transparent.

The lighting apparatus 18 shown in FIG. 2 and the lighting apparatus 118 shown in FIG. 3 included end-mounted LED elements 24 and 124, respectively. However, the LED element 224 of the lighting apparatus 218 is mid-mounted on the light guide 226, such that the LED element 224 is disposed along the interior surface 221. The LED element 224 may be adjacent to or embedded within the interior surface 221 of the light guide 226 between the first end 231 and the second end 232.

A first optic 230 is formed on a first end 231 of the light guide 226. The light guide 226 has a second end 232 substantially opposite the first end 231. The second end 232 includes a second optic 234 that redirects or reflects light toward the first optic 230.

The light guide 226 further includes a third optic 236, which is adjacent the LED element 224. The third optic 236 directs light from the LED element 224 toward both the first end 231 and the second end 232.

The light guide 226 may carry light from the LED element 224 to the first optic 230 substantially via total internal reflection. As shown in FIG. 4, the second optic 234 may be triangular to promote total internal reflection and redirect light downward (as viewed in the figure) toward the license plate 214. Alternatively, the second optic 234 or the third optic 236 may include reflective coatings.

The LED element 224 shown emits light from its face. However, the lighting apparatus 218 may alternatively have a side-emitting LED element, which emits light toward both the first end 231 and the second end 232. In configurations with the side-emitting LED element, the third optic 236 may not be necessary.

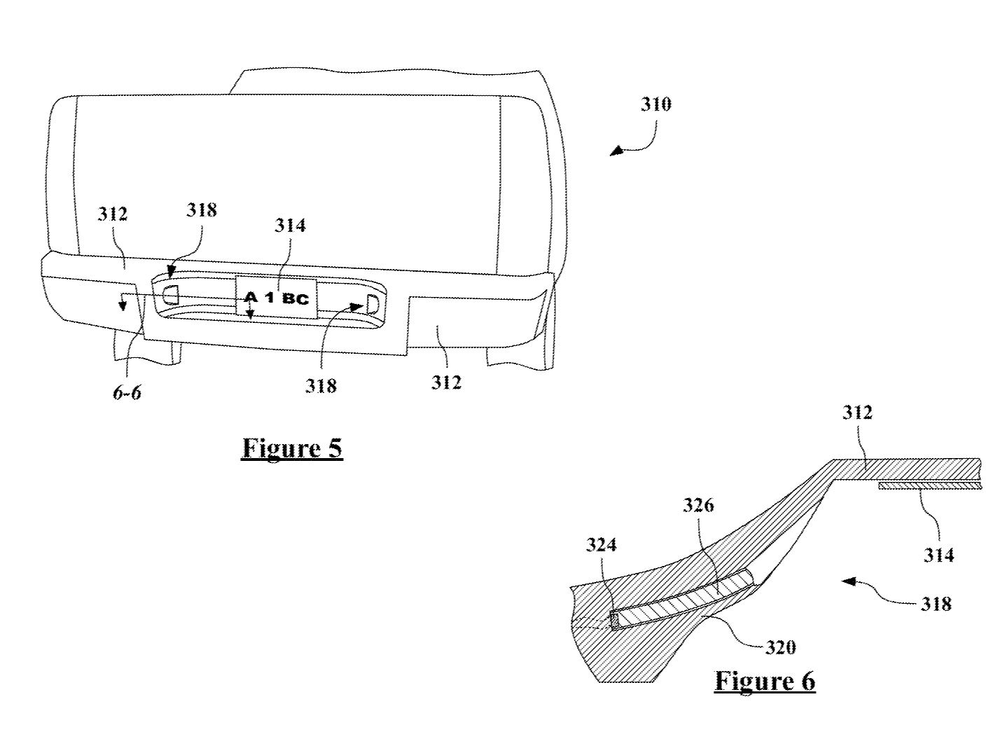

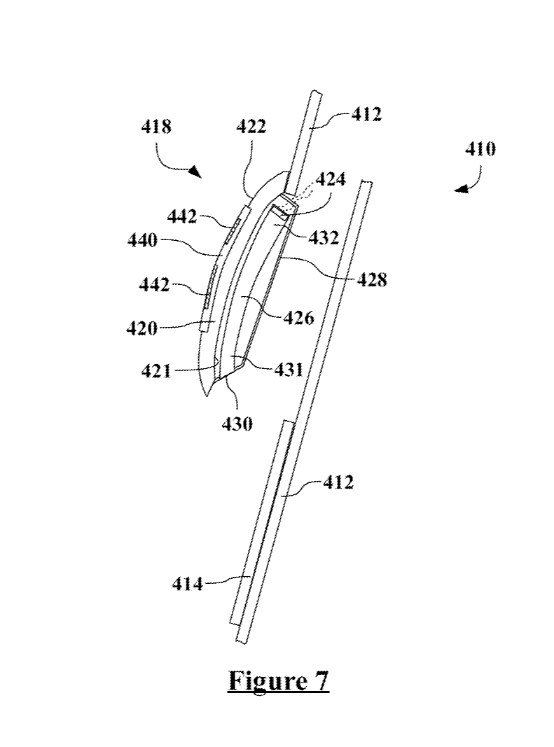

Referring now to FIG. 5 and FIG. 6, and with continued reference to FIGS. 1-4, there are shown two views of another vehicle 310. FIG. 5 shows an elevation of a rear portion of the vehicle 310 and FIG. 6 shows an illustrative cross section from the viewpoint of a line 6-6 of FIG. 5.

The rear of the vehicle 310 includes a bumper 312, but similar configurations may be incorporated into deck lids, lift gates, or tail lamp assemblies on the rear of the vehicle 310. A license plate 314 is attached to the bumper 312, and at least one lighting apparatus 318 illuminates the license plate 314. Although the vehicle 310 is illustrative of a pickup truck, other vehicle types may utilize the lighting apparatus 318.

The lighting apparatus 318 includes an appliqué 320 having an exterior surface that faces away from the license plate 314. The exterior surface is substantially opaque and may be covered with, for example, chrome-plating or paint.

In the configuration shown, the lighting apparatus 318 is side-mounted, as opposed to the top-mounted configurations shown in FIGS. 1-4. As used herein, especially with regard to the side-mounted applications, the appliqué 320 can include or be formed from portions of the bumper 312 for the vehicle 310. The bumper 312 houses an LED element 324 and a light guide 326 that carries light to the license plate 314.

The lighting apparatus 318 may also be side-mounted within a portion of a deck lid, lift gate, or tail lamp assembly adjacent to the license plate 314, as opposed to mounted within the bumper 312, as shown in FIGS. 5-6. Any of the other configurations of lighting apparatus shown in FIGS. 1-4 may also be side-mounted within a bumper, a deck lid, or a lift gate.

The lighting apparatus 318 may also be incorporated within a tail lamp assembly. Furthermore, the light apparatus 318, and also the top-mounted configurations shown in other figures, may be incorporated into lift gates of vehicles (for example, on pickup trucks, sport utility vehicles, or wagons).

Referring now to FIG. 7, and with continued reference to FIGS. 1-6, there is shown a portion of another vehicle 410 having a deck lid 412 with a license plate 414 attached thereto. A lighting apparatus 418 illuminates the license plate 414. FIG. 7 shows a plane-intersection view taken from the line 7-7 from FIG. 1, which is generally near the center of the vehicle 10. The lighting apparatus 418 shown in FIG. 7 may also be used with the vehicle 10 of FIG. 1 or the vehicle 310 shown in FIG. 5.

The lighting apparatus 418 includes an appliqué 420 having an exterior surface 422 that faces away from the license plate 414 and an interior surface 421 that faces toward the license plate 414. The exterior surface 422 is largely covered with an opaque coating, which may be, without limitation, chrome-plating or paint.

An LED element 424 acts as the light source for the lighting apparatus 418, and a light guide 426 carries light from the LED element 424 and casts it onto the license plate 414. In the configuration shown, a housing plate 428 is disposed between the light guide 426 and the license plate 414. The housing plate 428 may be substantially opaque, translucent, or clear.

A first optic 430 is formed on a first end 431 of the light guide 426. The light guide 426 has a second end 432 substantially opposite the first end 431. In the configuration shown in FIG. 7, the LED element 424 abuts, or is embedded within, the second end 432.

In the lighting apparatus 418, the appliqué 420 and the light guide 426 are separate elements, but may be assembled into a single module. Therefore, the lighting assembly 418 may be attached to the deck lid 412 as a single unit or module.

Additionally, the lighting apparatus 418 includes an emblem 440 disposed on the exterior surface 422 of the appliqué 420. The emblem 440 may be, for example and without limitation: a company logo, brand name, or model name of the vehicle 410.

The emblem 440 includes a translucent region 442. Light from the LED element 424 illuminates the emblem 440 by backlighting the translucent region 442. In some configurations, the translucent region 442 may be substantially transparent.

The emblem 440 may be formed in the opaque coating of the exterior surface 422 and differentiation of the translucent region 442 may be formed by masking out portions of the emblem. Alternatively, the emblem may be printed, such as through silk-screening or pad printing techniques, onto the appliqué 420, with the translucent regions 442 either left blank or printed with lesser coverage.

The emblem 440 may also be formed as a separate insert. For example, a plastic insert may be used for the emblem 440, with the translucent regions 442 formed from different-colored plastic or from portions of the insert that are not painted. In the configuration shown, the light guide 426 carries much of the light from the LED element 424 to the first optic 430 via total internal reflection. However, some of the light escapes the light guide 426 and hits the back of the emblem 440. This results in backlighting of the emblem 440.

When used on the rear of the vehicle 410, the emblem 440 or translucent region 442 may need to have a different color from the light cast onto the license plate 414. For example, the LED element 424 may emit white light for illuminating the license plate 414. However, the emblem 440 may be formed from red plastic—or covered in translucent red coating—such that the light emitted through the translucent region 442 toward the rear of the vehicle is red (similar to rear-facing running lights or tail lights).

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A lighting apparatus for illuminating a license plate, comprising:
an LED element;
an appliqué having an exterior surface facing away from the license plate and an interior surface facing toward the license plate, wherein the exterior surface is substantially opaque; and
a light guide between the exterior surface of the appliqué and the license plate, and having a first end with a first optic formed thereon,
wherein the light guide carries light from the LED element to the first optic, and
wherein the first optic casts light onto the license plate.

2. The lighting apparatus of claim 1, wherein the exterior surface is coated in one of chrome-plating and paint.

3. The lighting apparatus of claim 2, wherein the light guide has a second end substantially opposite the first end, and wherein the LED element is disposed at the second end.

4. The lighting apparatus of claim 3, further comprising:
an emblem disposed on the exterior surface of the appliqué, wherein the emblem is backlit by light from the LED element.

5. The lighting apparatus of claim 4, wherein the emblem includes a translucent region, wherein the translucent region is backlit by light from the LED element.

6. The lighting apparatus of claim 5, further comprising:
a housing plate disposed between the interior surface and the license plate, wherein the housing plate is substantially opaque.

7. The lighting apparatus of claim 3, wherein the light guide carries light from the LED element to the projection surface substantially via total internal reflection.

8. The lighting apparatus of claim 1, wherein the appliqué and the light guide are integrated into a one-piece, unitary element, such that the first end of the light guide is also the first end of the appliqué and the exterior surface of the appliqué is also the exterior surface of the light guide.

9. The lighting apparatus of claim 8, wherein the LED element includes a plurality of individual LED's distributed across the second end of the light guide.

10. The lighting apparatus of claim 1, wherein the light guide has a second end substantially opposite the first end, and the second end includes a second optic that reflects light toward the first optic, and wherein the LED element is disposed on the interior surface of the light guide between the first end and the second end.

11. The lighting apparatus of claim 10, wherein the light guide further includes a third optic adjacent the LED element, wherein the third optic directs light from the LED element toward both the first end and the second end.

12. A lighting apparatus for illuminating a license plate, comprising:
an LED element;
an appliqué having an exterior surface facing away from the license plate and an interior surface facing toward the license plate, wherein the exterior surface is substantially covered with an opaque coating; and
a light guide between the exterior surface of the appliqué and the license plate, and having a first end with a first optic formed thereon and a second end substantially opposite the first end,
wherein the light guide carries light from the LED element to the first optic, and
wherein the first optic casts light onto the license plate.

13. The lighting apparatus of claim 12, further comprising:
a housing plate disposed between the interior surface and the license plate.

14. The lighting apparatus of claim 13, further comprising:
an emblem disposed on the exterior surface of the appliqué, wherein the emblem is backlit by light from the LED element.

15. The lighting apparatus of claim 14, wherein the emblem includes a translucent region, wherein the translucent region is backlit by light from the LED element.

16. The lighting apparatus of claim 13, wherein the second end further includes a second optic that reflects light toward the first optic, and wherein the LED element abuts the interior surface of the light guide between the first end and the second end.

17. The lighting apparatus of claim 16, wherein the light guide further includes a third optic adjacent the LED element, wherein the third optic directs light from the LED element toward both the first end and the second end.

18. The lighting apparatus of claim 17, wherein the appliqué and the light guide are integrated into a one-piece, unitary element, such that the first end of the light guide is also the first end of the appliqué and the exterior surface of the appliqué is also the exterior surface of the light guide.
